(19) United States
(12) Patent Application Publication
(10) Pub. No.: US 2024/0021801 A1
(43) Pub. Date: Jan. 18, 2024

(54) POSITIVE ELECTRODE MATERIAL AND BATTERY

(71) Applicant: Panasonic Intellectual Property Management Co., Ltd., Osaka (JP)

(72) Inventor: YUMI MIYAMOTO, Osaka (JP)

(21) Appl. No.: 18/473,312

(22) Filed: Sep. 25, 2023

Related U.S. Application Data
(63) Continuation of application No. PCT/JP2022/010442, filed on Mar. 10, 2022.

(30) Foreign Application Priority Data
Apr. 20, 2021 (JP) 2021-071446

(51) Int. Cl. H01M 4/36; H01M 10/0562; H01M 4/505; H01M 4/62; H01M 10/0525

(52) U.S. Cl. CPC H01M 4/366; H01M 10/0562; H01M 4/505; H01M 4/62; H01M 10/0525; H01M 2004/028

(57) ABSTRACT

A positive electrode material according to the present disclosure includes a positive electrode active material, a first solid electrolyte material coating at least a portion of a surface of the positive electrode active material, and a second electrolyte material. The second electrolyte material contains Li and at least one selected from the group consisting of Cl and Br, the first solid electrolyte material contains Li, Nb, and O, and the positive electrode active material contains a material represented by the following composition formula (1):

LiNiₓMn₂₋ₓO₄ Formula (1)

where x satisfies 0<x<2.

### BACKGROUND

### 1. Technical Field

The present disclosure relates to a positive electrode material and a battery.

### 2. Description of the Related Art

WO2019/146216 discloses an all-solid-state battery including a positive electrode material in which lithium niobate (hereinafter, may be also referred to as LiNbO₃) coats at least a portion of a surface of a positive electrode active material containing nickel, cobalt, and manganese.

### SUMMARY

One non-limiting and exemplary embodiment provides a positive electrode material that increases charge and discharge capacity of a battery.

In one general aspect, the techniques disclosed here feature a positive electrode material including a positive electrode active material, a first solid electrolyte material coating at least a portion of a surface of the positive electrode active material, and a second electrolyte material, wherein the second electrolyte material contains Li and at least one selected from the group consisting of Cl and Br, the first solid electrolyte material contains Li, Nb, and O, and the positive electrode active material contains a material represented by the following composition formula (1):

LiNiₓMn₂₋ₓO₄ Formula (1)

where x satisfies 0<x<2.

The present disclosure provides a positive electrode material that increases charge and discharge capacity of a battery.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view illustrating a schematic configuration of a positive electrode material according to a first embodiment;

FIG. 2 is a cross-sectional view illustrating a schematic configuration of a battery according to a second embodiment; and

FIG. 3 is a cross-sectional view illustrating a schematic configuration of a battery according to a third embodiment.

### DETAILED DESCRIPTIONS

### Underlying Knowledge Forming Basis of the Present Disclosure

WO2019/146216 discloses an all-solid-state battery that includes a positive electrode material that contains a positive electrode active material containing nickel, cobalt, and manganese, a coating material that coats at least a portion of a surface of the positive electrode active material, and a halide solid electrolyte. The coating material that coats the surface of the positive electrode active material is a solid electrolyte material, and the solid electrolyte material is lithium niobate.

The positive electrode material containing a halide solid electrolyte has been conventionally examined for its resistance to oxidative degradation. The halide solid electrolyte is a material that contains halogen elements, such as fluorine (F), chlorine (Cl), bromine (Br), and iodine (I) as anions.

In a battery including a halide solid electrolyte that contains at least one element selected from the group consisting of chlorine, bromine, and iodine in the positive electrode material, the halide solid electrolyte oxidizes and degrades during charging, and the oxidative degradant acts as a resistance layer, leading to an increase in the internal resistance of the battery during charging. This problem may be caused by the oxidation reaction of the one of the elements selected from the group consisting of chlorine, bromine, and iodine in the halide solid electrolyte. Herein, the oxidation reaction includes not only a common charge reaction in which lithium and electrons are taken from the positive electrode active material of the positive electrode material, but also a side reaction in which electrons are taken from the halide solid electrolyte being in contact with the positive electrode active material and containing at least one element selected from the group consisting of chlorine, bromine, and iodine. The oxidation reaction forms an oxidative degradation layer having poor lithium-ion conductivity between the positive electrode active material and the halide solid electrolyte, and the oxidative degradation layer seems to act as a large interfacial resistance during an electrode reaction of the positive electrode. It is known that this problem is more likely to occur when a positive electrode active material having a potential versus Li of greater than 3.9 V is used than when a positive electrode active material having a potential versus Li of less than or equal to 3.9 V is used, and not only the halide solid electrolyte but also, for example, a sulfide solid electrolyte degrades if used as the solid electrolyte.

WO2019/146216 discloses a battery including a positive electrode layer including a positive electrode active material coated with lithium niobate, and a halide solid electrolyte. The coating of the positive electrode active material with the coating material reduces the possibility that the oxidative degradation layer will be formed by the halide solid electrolyte, reducing an increase in the internal resistance. This reduces a decrease in the charge and discharge capacity of the battery.

The inventor conducted a comprehensive study on the positive electrode material containing a coated positive electrode active material to find a configuration that can further reduce a decrease in charge and discharge capacity of a battery. As a result, the inventor has found that a positive electrode active material that contains an oxide composed of Li, Ni, Mn, and O and whose surface is coated with a solid electrolyte material containing Li, Nb, and O can further reduce a decrease in charge and discharge capacity of the battery.

With the above findings, the inventor has arrived at the following positive electrode material of the present disclosure.

The positive electrode material according to an aspect of the present disclosure includes a positive electrode active material, a first solid electrolyte material, and a second electrolyte material, wherein the first solid electrolyte material coats at least a portion of a surface of the positive electrode active material and contains Li, Nb, and O, the second electrolyte material contains Li and at least one selected from the group consisting of Cl and Br, and the positive electrode active material contains a material represented by the following composition formula (1):

LiNiₓMn₂₋ₓO₄ Formula (1)

where x satisfies 0<x<2.

With this configuration, the positive electrode material of the present disclosure can have higher oxidation resistance and can increase the charge and discharge capacity of the battery.

### SUMMARY OF AN ASPECT OF THE DISCLOSURE

A positive electrode material according to a first aspect of the present disclosure includes a positive electrode active material, a first solid electrolyte material coating at least a portion of a surface of the positive electrode active material, and a second electrolyte material, wherein the second electrolyte material contains Li and at least one selected from the group consisting of Cl and Br, the first solid electrolyte material contains Li, Nb, and O, and the positive electrode active material contains a material represented by the following composition formula (1):

LiNiₓMn₂₋ₓO₄ Formula (1)

where x satisfies 0<x<2.

In the positive electrode material according to the first aspect, the positive electrode active material whose surface is at least partially coated with the first solid electrolyte material has high oxidation resistance. This can reduce a decrease in charge and discharge capacity caused by oxidative degradation of the second electrolyte material in the battery, increasing charge and discharge capacity of the battery.

According a second aspect of the present disclosure, for example, in the positive electrode material according to the first aspect, the composition formula (1) may satisfy 0<x<1.

The positive electrode material according to the second aspect can increase the charge and discharge capacity of the battery.

According to a third aspect of the present disclosure, for example, in the positive electrode material according to the second aspect, the composition formula (1) may satisfy x=0.5.

The positive electrode material according to the third aspect can increase the charge and discharge capacity of the battery.

According to a fourth aspect of the present disclosure, for example, in the positive electrode material according to any one of the first to third aspects, the first solid electrolyte material may contain lithium niobate.

The positive electrode material according to the fourth aspect can increase the charge and discharge capacity of the battery.

According to a fifth aspect of the present disclosure, for example, in the positive electrode material according to any one of the first to fourth aspects, a mass ratio of the first solid electrolyte material to the positive electrode active material may be greater than or equal to 0.50%.

The positive electrode material according to the fifth aspect can increase the charge and discharge capacity of the battery.

According to a sixth aspect of the present disclosure, for example, in the positive electrode material according to the fifth aspect, a mass ratio of the first solid electrolyte material to the positive electrode active material may be greater than or equal to 0.93%.

The positive electrode material according to the sixth aspect can increase the charge and discharge capacity of the battery.

According to a seventh aspect of the present disclosure, for example, in the positive electrode material according to any one of the first to sixth aspects, the second electrolyte material may further contain at least one selected from the group consisting of metallic elements other than Li and metalloid elements.

The positive electrode material according to the seventh aspect can increase the charge and discharge capacity of the battery.

According to an eighth aspect of the present disclosure, for example, in the positive electrode material according to the seventh aspect, the second electrolyte material may contain a material represented by the following composition formula (2):

Li_{α}M_{β}X_{γ}O₆₇ Formula (2)

where α, β, and γ are values greater than 0, δ is a value greater than or equal to 0,

M is at least one selected from the group consisting of metallic elements other than Li and metalloid elements, and

X is at least one element selected from the group consisting of Cl and Br.

The positive electrode material according to the eighth aspect can further improve the ionic conductivity of the second electrolyte material. This can further reduce the resistance caused by migration of Li ions of the positive electrode material and thus can more efficiently reduce an increase in the internal resistance of the battery during charging.

According to a ninth aspect of the present disclosure, for example, in the positive electrode material according to the eighth aspect, M may contain at least one selected from the group consisting of Y and Ta.

The positive electrode material according to the ninth aspect can further improve the ionic conductivity of the second electrolyte material. This can further reduce the resistance caused by migration of Li ions of the positive electrode material, and thus can more efficiently reduce an increase in the internal resistance of the battery during charging.

According to a tenth aspect of the present disclosure, for example, in the positive electrode material according to the eighth or ninth aspect, the composition formula (2) may satisfy:

1≤α≤4;

0<β≤2;

3≤γ7; and

0<δ≤2.

The positive electrode material according to the tenth aspect can further improve the ionic conductivity of the second electrolyte material. This can further reduce the resistance caused by the migration of Li ions of the positive electrode material and thus can more efficiently reduce an increase in the internal resistance of the battery during charging.

According to an eleventh aspect of the present disclosure, for example, in the positive electrode material according to any one of the first to tenth aspects, the second electrolyte material may contain a sulfide solid electrolyte.

The positive electrode material according to the eleventh aspect can further improve the ionic conductivity of the second electrolyte material. This can further reduce the resistance caused by the migration of Li ions of the positive electrode material and thus can more efficiently reduce an increase in the internal resistance of a battery during charging.

According to a twelfth aspect of the present disclosure, for example, in the positive electrode material according to any one of the first to eleventh aspects, the second electrolyte material may contain Li₆PS₅Cl.

The positive electrode material according to the twelfth aspect can further improve the ionic conductivity of the second electrolyte material. This can further reduce the resistance caused by migration of Li ions of the positive electrode material and thus can more efficiently reduce an increase in the internal resistance of the battery during charging.

According to a thirteenth aspect of the present disclosure, for example, in the positive electrode material according to any one of the first to twelfth aspects, the first solid electrolyte material may be located between the positive electrode active material and the second electrolyte material.

In the positive electrode material according to the thirteenth aspect, the first solid electrolyte material having high oxidation resistance is located between the positive electrode active material and the second electrolyte material. This can reduce the oxidative degradation of the second electrolyte material, reducing an increase in the internal resistance of the battery during charging.

A battery according to a fourteenth aspect of the present disclosure includes a positive electrode, a negative electrode, and an electrolyte layer located between the positive electrode and the negative electrode, wherein the positive electrode contains the positive electrode material according to any one of the first to thirteenth aspects.

In the battery according to the fourteenth aspect, a decrease in the charge and discharge capacity can be reduced.

According to a fifteenth aspect of the present disclosure, for example, in the battery according to the fourteenth aspect, the electrolyte layer may include a first electrolyte layer and a second electrolyte layer, and

the first electrolyte layer may be in contact with the positive electrode, and the second electrolyte layer may be in contact with the negative electrode.

According to a sixteenth aspect of the present disclosure, for example, in the battery according to the fifteenth aspect, the first electrolyte layer may contain a material having a composition identical to that of the second electrolyte material.

The battery according to the sixteenth aspect has an improved charge and discharge capacity.

According to a seventeenth aspect of the present disclosure, for example, in the battery according to the fifteenth or sixteenth aspect, the second electrolyte layer may contain a material having a different composition than the first solid electrolyte material.

The battery according to the seventeenth aspect has an improved charge and discharge capacity.

Hereafter, embodiments of the present disclosure will be described with reference to the attached drawings.

### First Embodiment

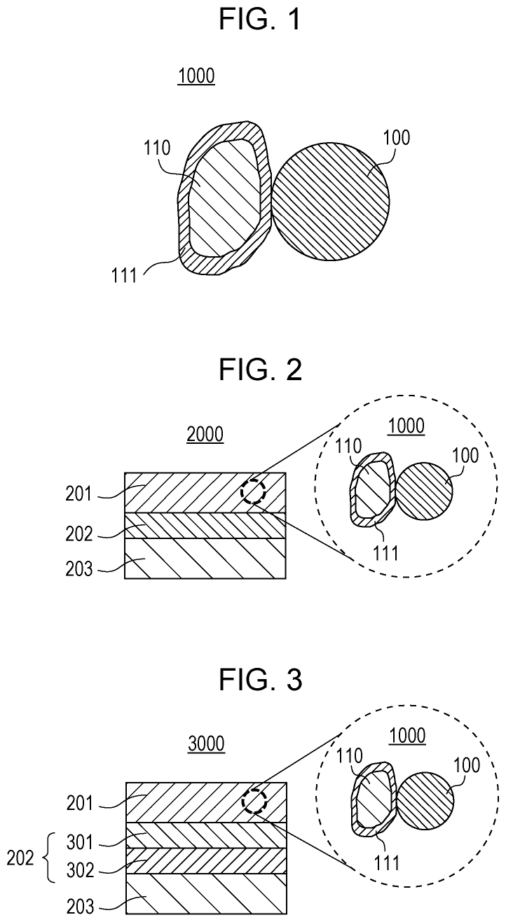

FIG. 1 is a cross-sectional view illustrating a schematic configuration of a positive electrode material 1000 according to a first embodiment. The positive electrode material 1000 includes a positive electrode active material 110, a first solid electrolyte material 111 that coats at least a portion of a surface of the positive electrode active material 110, and a second electrolyte material 100. The positive electrode active material 110 contains an oxide composed of Li, Ni, Mn, and O. The second electrolyte material 100 contains Li and at least one selected from the group consisting of Cl and Br. The first solid electrolyte material 111 contains Li, Nb, and O.

With the above configuration, the positive electrode material 1000 has higher oxidation resistance. Thus, the positive electrode material 1000 can reduce an increase in the internal resistance of the battery during charging. Furthermore, the first solid electrolyte material 111 has high ionic conductivity. This enables the positive electrode material 1000 to have low interface resistance between the first solid electrolyte material 111 and the positive electrode active material 110.

The positive electrode active material 110 contains a material represented by the following composition formula (1):

LiNiₓMn₂₋ₓO₄ Formula (1)

where x satisfies 0<x<2.

The composition formula (1) may satisfy 0<x<1.

The composition formula (1) may satisfy x=0.5. In other words, the positive electrode active material 110 may contain LiNi_{0.5}Mn_{1.5}O₄.

The oxide represented by these chemical formulas is a material obtained by replacing a part of Mn in LiMn₂O₄ having a spinel structure with Ni and is suitable for increasing the operating voltage of the battery. An oxide composed of Li, Ni, Mn, and O may also have a spinel structure. The term “oxide composed of Li, Ni, Mn, and O” means that the oxide does not intentionally include additional elements other than Li, Ni, Mn, and except for inevitable impurities. Furthermore, the material represented by the composition formula (1) does not contain Co, making the material inexpensive. The above configuration can provide a low-cost positive electrode material 1000 that can improve the charge and discharge efficiency of the battery.

The positive electrode active material 110 may be composed solely of LiNi_{0.5}Mn_{1.5}O₄.

The above configuration can reduce a decrease in charge and discharge capacity of the battery.

The first solid electrolyte material 111 may contain lithium niobate.

The first solid electrolyte material 111 may contain lithium niobate as a main component. Here, the “main component” means a component most abundant by mass.

The first solid electrolyte material 111 may be composed solely of lithium niobate.

With the above configuration, the first solid electrolyte material 111 can have higher ionic conductivity. This enables the positive electrode material 1000 to have low interface resistance between the first solid electrolyte material 111 and the positive electrode active material 110.

The mass ratio of the first solid electrolyte material 111 to the positive electrode active material 110 may be greater than or equal to 0.50%. The mass ratio of the first solid electrolyte material 111 to the positive electrode active material 110 may be greater than or equal to 0.60%, greater than or equal to 0.70%, or greater than or equal to 0.80%.

The mass ratio of the first solid electrolyte material 111 to the positive electrode active material 110 may be greater than or equal to 0.93%.

The mass ratio of the first solid electrolyte material 111 to the positive electrode active material 110 may be less than or equal to 10.0%, or less than or equal to 7.0%.

The mass ratio of the first solid electrolyte material 111 to the positive electrode active material 110 may be greater than or equal to 0.50% and less than or equal to 10.0%, or greater than or equal to 0.50% and less than or equal to 7.0%. The mass ratio of the first solid electrolyte material 111 to the positive electrode active material 110 may be greater than or equal to 2.50% and less than or equal to 10.0%, or greater than or equal to 2.50% and less than or equal to 7.0%.

The upper and lower limits of the mass ratio of the first solid electrolyte material 111 to the positive electrode active material 110 may be any combination of values selected from the values 0.93, 2.3, 4.7, and 9.3.

The above configuration can improve charge and discharge efficiency of the battery including the positive electrode material 1000.

The second electrolyte material 100 may further contain at least one selected from the group consisting of metallic elements other than Li, and metalloid elements.

The “metalloid elements” include B, Si, Ge, As, Sb, and Te.

The “metallic elements” include all elements of group Ito group XII of the periodic table except for hydrogen, and all elements of group XIII to group XVI except for B, Si, Ge, As, Sb, Te, C, N, P, O, S, and Se. That is, the elements are included in an element group that can become a cation when forming an inorganic compound with a halogen compound.

The second electrolyte material 100 may contain a material represented by the following composition formula (2):

Li_{α}M_{β}X_{γ}O₆₇ Formula (2)

where α, β, and γ are values greater than 0, δ is a value greater than or equal to 0, M is at least one selected from the group consisting of metallic elements other than Li and metalloid elements, and X is at least one element selected from the group consisting of Cl and Br.

The above configuration can further improve the ionic conductivity of the second electrolyte material 100. This can further reduce the resistance caused by the migration of Li ions of the positive electrode material 1000.

In the composition formula (2), M may contain at least one selected from the group consisting of Y and Ta. In other words, the second electrolyte material 100 may contain at least one selected from the group consisting of Y and Ta as a metallic element.

The above configuration can further improve the ionic conductivity of the second electrolyte material 100. This can further reduce the resistance caused by the migration of Li ions of the positive electrode material 1000.

The composition formula (2) may satisfy 1≤α≤4, 0<β≤2, 3≤γ<7, and 0≤δ≤2.

The above configuration can further improve the ionic conductivity of the second electrolyte material 100. This can further reduce the resistance caused by the migration of Li ions of the positive electrode material 1000.

The composition formula (2) may satisfy 2.5≤α≤3, 1≤β≤1.1, γ=6, and δ=0.

The second electrolyte material 100 containing Y may be, for example, a compound represented by the composition formula LiₐMe_{b}Y_{c}X₆, where a+m′b+3 c=6 and c>0 are satisfied. Me is at least one element selected from the group consisting of metallic elements other than Li and Y and metalloid elements. In addition, m′ is the valence of Me.

Me may be at least one element selected from the group consisting of Mg, Ca, Sr, Ba, Zn, Sc, Al, Ga, Bi, Zr, Hf, Ti, Sn, Ta, and Nb.

The above configuration can further improve the ionic conductivity of the second electrolyte material 100. This can further reduce the resistance caused by the migration of Li ions of the positive electrode material 1000.

The second electrolyte material 100 may be a material represented by the following composition formula (A1):

Li_{6-3d}Y_{d}X₆ Formula (A1)

where X is a halogen element and contains Cl. Furthermore, 0<d<2 is satisfied.

The above configuration can further improve the ionic conductivity of the second electrolyte material 100. This can further reduce the resistance caused by the migration of Li ions of the positive electrode material 1000.

The second electrolyte material 100 may be a material represented by the following composition formula (A2):

Li₃YX₆ Formula (A2)

where X is a halogen element and contains Cl.

The above configuration can further improve the ionic conductivity of the second electrolyte material 100. This can further reduce the resistance caused by the migration of Li ions of the positive electrode material 1000.

The second electrolyte material 100 may be a material represented by the following composition formula (A3):

Li_{3-3δ}Y_{1+δ}Cl₆ Formula (A3)

where 0<δ≤0.15 is satisfied.

The above configuration can further improve the ionic conductivity of the second electrolyte material 100. This can further reduce the resistance caused by the migration of Li ions of the positive electrode material 1000.

The second electrolyte material 100 may be a material represented by the following composition formula (A4):

Li_{3-3δ+a4}Y_{1+δ-a4}Meₐ₄Cl₆₋ₓ₄Brₓ₄ Formula (A4)

where Me is at least one element selected from the group consisting of Mg, Ca, Sr, Ba, and Zn. Furthermore, −1<δ<2, 0<a4<3, 0<(3−3δ+a4), 0<(1+δ−a4), and 0≤x4<6 are satisfied.

The above configuration can further improve the ionic conductivity of the second electrolyte material 100. This can further reduce the resistance caused by the migration of Li ions of the positive electrode material 1000.

The second electrolyte material 100 may be a material represented by the following composition formula (A5):

Li_{3-3δ}Y_{1+δ-a5}Meₐ₅Cl₆₋ₓ₅Brₓ₅ Formula (A5)

where Me is at least one element selected from the group consisting of Al, Sc, Ga, and Bi. Furthermore, −1<δ<1, 0<a5<2, 0<(1+δ−a5), and 0≤x5<6 are satisfied.

The above configuration can further improve the ionic conductivity of the second electrolyte material 100. This can further reduce the resistance caused by the migration of Li ions of the positive electrode material 1000.

The second electrolyte material 100 may be a material represented by the following composition formula (A6):

Li_{3-3δ-a6}Y_{1+δ-a6}Meₐ₆Cl₆₋ₓ₆Brₓ₆ Formula (A6)

where Me is at least one element selected from the group consisting of Zr, Hf, and Ti. Furthermore, −1<δ<1, 0<a6<1.5, 0<(3−3δ−a6), 0<(1+δ−a6), and 0≤x6<6 are satisfied.

The second electrolyte material 100 may be a material represented by the following composition formula (A7):

Li_{3-3δ-2a7}Y_{1+δ-a7}Meₐ₇Cl₆₋ₓ₇Brₓ₇ Formula (A7)

where Me is at least one element selected from the group consisting of Ta and Nb. Furthermore, −1<δ<1, 0<a7<1.2, 0<(3−3δ−2a7), 0<(1+δ−a7), and 0≤x7<6 are satisfied.

Examples of the second electrolyte material 100 include Li₃ YX₆, Li₂MgX₄, Li₂FeX₄, Li(Al, Ga, In)X₄, and Li₃(Al, Ga, In)X₆. Here, X contains Cl. In the present disclosure, when an element in a formula is expressed, for example, as “(Al, Ga, In)”, the element is at least one element selected from the group consisting of the elements in parentheses. In other words, “(Al, Ga, In)” is synonymous with “at least one selected from the group consisting of Al, Ga, and In”. The same holds for the other elements.

The second electrolyte material 100 may contain Li₆PS₅Cl. The second electrolyte material 100 may be Li₆PS₅Cl.

The second electrolyte material 100 may further contain a sulfide solid electrolyte. Examples of the sulfide solid electrolyte may include Li₂S—P₂S₅, Li₂S—SiS₂, Li₂S—B₂S₃, Li₂ S—GeS₂, Li_{3.25}Ge_{0.25}Po_{0.75}S₄, Li₁₀GeP₂S₁₂, and Li₆PS₅Cl. Furthermore, LiX, Li₂O, M′O_{q}, LiₚM′O_{q}, or the like may be added to the above. Herein, X represents at least one element selected from the group consisting of F, Cl, Br, and I. M′ represents at least one element selected from the group consisting of P, Si, Ge, B, Al, Ga, In, Fe, and Zn. Each of p and q represents a natural number.

The sulfide solid electrolyte may contain lithium sulfide and phosphorus sulfide. The sulfide solid electrolyte may be Li₆PS₅Cl.

The second electrolyte material 100 may be a solid electrolyte material.

The second electrolyte material 100 may contain an electrolyte solution.

The electrolyte solution contains water or a non-aqueous solvent, and a lithium salt dissolved in the solvent.

Examples of the solvent include water, a cyclic carbonate ester solvent, a chain carbonate ester solvent, a cyclic ether solvent, a chain ether solvent, a cyclic ester solvent, a chain ester solvent, and a fluorine solvent.

Examples of the cyclic carbonate ester solvent include ethylene carbonate, propylene carbonate, and butylene carbonate.

Examples of the chain carbonate ester solvent include dimethyl carbonate, ethyl methyl carbonate, and diethyl carbonate.

Examples of the cyclic ether solvent include tetrahydrofuran, 1,4-dioxane, and 1,3-dioxolane.

Examples of the chain ether solvent include 1,2-dimethoxyethane and 1,2-diethoxyethane.

Examples of the cyclic ester solvent include γ-butyrolactone.

Examples of the chain ester solvent include methyl acetate.

Examples of the fluorine solvent include fluoroethylene carbonate, methyl fluoropropionate, fluorobenzene, fluoroethyl methyl carbonate, and fluorodimethylene carbonate.

One of the above solvents may be selected and used alone as the solvent. Alternatively, two or more of the above solvents may be selected and used in combination as the solvent.

The electrolyte solution may contain at least one fluorine solvent selected from the group consisting of fluoroethylene carbonate, methyl fluoropropionate, fluorobenzene, fluoroethyl methyl carbonate, and fluorodimethylene carbonate.

Examples of the lithium salt may include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One of the above lithium salts may be selected and used alone as the lithium salt. Alternatively, two or more of the above lithium salts may be selected and used in combination as the lithium salt. The concentration of the lithium salt is, for example, in a range of 0.1 to 15 mol/liter.

The positive electrode material 1000 may further contain a positive electrode active material other than the positive electrode active material 110 composed of Li, N, Mn, and O.

The positive electrode active material contains a material capable of intercalation and deintercalation of metal ions (for example, lithium ions). Examples of the positive electrode active material other than the positive electrode active material 110 include lithium-containing transition metal oxides, transition metal fluorides, polyanionic materials, fluorinated polyanionic materials, transition metal sulfides, transition metal oxysulfides, and transition metal oxynitrides. Examples of the lithium-containing transition metal oxides include Li(Ni, Co, A )O₂, Li(Ni, Co, Mn)O₂, and LiCoO₂. In particular, the employment of the lithium-containing transition metal oxide can reduce the production cost of the positive electrode material 1000 and increase the average discharge voltage.

The first solid electrolyte material 111 may be located between the positive electrode active material 110 and the second electrolyte material 100.

The above configuration that has the first solid electrolyte material 111 having high oxidation resistance between the positive electrode active material 110 and the second electrolyte material 100 can reduce oxidative degradation of the second electrolyte material 100. This can reduce a decrease in capacity of the battery including the positive electrode material 1000 during charging.

The thickness of the first solid electrolyte material 111 coating at least a portion of a surface of the positive electrode active material 110 may be greater than or equal to 1 nm and less than or equal to 500 nm.

When the thickness of the first solid electrolyte material 111 is greater than or equal to 1 nm, the positive electrode active material 110 and the second electrolyte material 100 are less likely to be in direct contact with each other, reducing oxidative degradation of the second electrolyte material 100. This can improve the charge and discharge efficiency of the battery including the positive electrode material 1000. When the thickness of the first solid electrolyte material 111 is less than or equal to 500 nm, the thickness of the first solid electrolyte material 111 is not too thick. This makes the internal resistance of the battery including the positive electrode material 1000 to be sufficiently small, increasing the energy density of the battery.

The thickness of the first solid electrolyte material 111 may be measured by any method. For example, the thickness of the first solid electrolyte material 111 may be determined by direct observation using a transmission electron microscope.

The mass ratio of the first solid electrolyte material 111 to the positive electrode active material 110 may be greater than or equal to 0.01% and less than or equal to 30%.

When the mass ratio of the first solid electrolyte material 111 to the positive electrode active material 110 is greater than or equal to 0.01%, the positive electrode active material 110 and the second electrolyte material 100 are less likely to be in direct contact with each other, reducing oxidative degradation of the second electrolyte material 100. This can improve charge and discharge efficiency of the battery including the positive electrode material 1000. When the mass ratio of the first solid electrolyte material 111 to the positive electrode active material 110 is less than or equal to 30%, the first solid electrolyte material 111 is not too thick. This makes the internal resistance of the battery including the positive electrode material 1000 to be sufficiently small, increasing the energy density of the battery.

The first solid electrolyte material 111 may uniformly coat the surface of the positive electrode active material 110. This reduces the possibility of direct contact between the positive electrode active material 110 and the second electrolyte material 100, reducing the side reactions of the second electrolyte material 100. This can further improve charge and discharge properties of the battery including the positive electrode material 1000 and can also reduce a decrease in the capacity of the battery.

The first solid electrolyte material 111 may coat a portion of the surface of the positive electrode active material 110. The positive electrode active materials 110 are in direct contact with each other through the portions not having the first solid electrolyte material 111, improving the electronic conductivity between the positive electrode active materials 110. This enables the battery including the positive electrode material 1000 to operate with a high output.

The first solid electrolyte material 111 may coat greater than or equal to 30%, greater than or equal to 60%, or greater than or equal to 90%, of the surface of the positive electrode active material 110. The first solid electrolyte material 111 may coat substantially the entire surface of the positive electrode active material 110.

The first solid electrolyte material 111 may be in direct contact with the surface of the positive electrode active material 110.

The surface of the positive electrode active material 110 may be at least partially coated with a coating material different from the first solid electrolyte material 111.

Examples of the coating material include a sulfide solid electrolyte, an oxide solid electrolyte, and a fluoride solid electrolyte. Examples of the sulfide solid electrolyte used as the coating material may be the same as those listed as examples of the second electrolyte material 100. Examples of the oxide solid electrolyte used as the coating material include Li—B—O compounds such as LiBO₂ and Li₃BO₃, Li—Al—O compounds such as LiAlO₂, Li—Si—O compounds such as Li₄SiO₄, Li—Ti—O compounds such as Li₂SO₄ and Li₄Ti₅O₁₂, Li—Zr—O compounds such as Li₂ZrO₃, Li—Mo—O compounds such as Li₂MoO₃, Li—V—O compounds such as LiV₂O₅, Li—W—O compounds such as Li₂WO₄, and Li—P—O compounds such as Li₃PO₄. Examples of the fluoride solid electrolytes used as the coating material include a solid electrolyte containing Li, Ti, Ml, and F, in which M1 is at least one element selected from the group consisting of Ca, Mg, Al, Y, and Zr.

The above configuration can further improve the oxidation resistance of the positive electrode material 1000. This can reduce a decrease in the capacity of the battery during charging.

The positive electrode active material 110 and the first solid electrolyte material 111 may be separated by the coating material and not be in direct contact with each other.

The above configuration can improve the oxidation resistance of the positive electrode material 1000. This can reduce a decrease in the capacity of the battery during charging.

The second electrolyte material 100 may have any shape. When the second electrolyte material 100 is a powder material, the shape may be, for example, needlelike, spherical, or ellipsoidal. For example, the shape of the second electrolyte material 100 may be granular.

For example, when the shape of the second electrolyte material 100 is granular (for example, spherical), the median diameter of the second electrolyte material 100 may be less than or equal to 100 μm. When the median diameter of the second electrolyte material 100 is less than or equal to 100 μm, the positive electrode active material 110 and the second electrolyte material 100 can be in a good dispersion state in the positive electrode material 1000. This improves the charge and discharge properties of the battery including the positive electrode material 1000.

The median diameter of the second electrolyte material 100 may be less than or equal to 10 μm. With this configuration, the positive electrode active material 110 and the second electrolyte material 100 can be in a good dispersion state in the positive electrode material 1000.

In the first embodiment, the median diameter of the second electrolyte material 100 may be smaller than the median diameter of the positive electrode active material 110. With this configuration, the second electrolyte material 100 and the positive electrode active material 110 can be in a better dispersion state in the positive electrode material 1000.

The median diameter of the positive electrode active material 110 may be greater than or equal to 0.1 μm and less than or equal to 100 μm.

When the median diameter of the positive electrode active material 110 is greater than or equal to 0.1 μm, the positive electrode active material 110 and the second electrolyte material 100 can be in a good dispersion state in the positive electrode material 1000. This improves the charge and discharge properties of the battery including the positive electrode material 1000. When the median diameter of the positive electrode active material 110 is less than or equal to 100 μm, the lithium diffusion rate in the positive electrode active material 110 increases. This enables the battery including the positive electrode material 1000 to operate with a high output.

The median diameter of the positive electrode active material 110 may be larger than the median diameter of the second electrolyte material 100. With this configuration, the positive electrode active material 110 and the second electrolyte material 100 can be in a good dispersion state.

In the present disclosure, the “median diameter” means a particle diameter at which the cumulative volume is 50% in the volume-based particle size distribution. The volume-based particle size distribution is measured with, for example, a laser diffraction measurement apparatus or an image analyzer.

In the positive electrode material 1000, the second electrolyte material 100 and the first solid electrolyte material 111 may be in contact with each other, as illustrated in FIG. 1. At this time, the first solid electrolyte material 111 and the positive electrode active material 110 are in contact with each other.

The positive electrode material 1000 may contain multiple second electrolyte materials 100 and multiple positive electrode active materials 110.

The amount of the second electrolyte material 100 and the amount of the positive electrode active material 110 in the positive electrode material 1000 may be equal or different from each other.

### Method for Producing Positive Electrode Material 1000

The positive electrode material 1000 according to the first embodiment may be produced, for example, by the following method.

First, lithium niobate, which is the first solid electrolyte material 111, is formed, on the surface of LiNi_{0.5} Mn_{1.5}O₄, which is an example of the positive electrode active material 110, by the following procedure.

After LiNi_{0.5}Mn_{1.5}O₄ is brought into contact with an ethanol solution in which a niobium source and a lithium source are dissolved, the ethanol is evaporated to produce powder. The resulting powder is heat-treated at 350° C., for example, for 3 hours. This produces the positive electrode active material 110 whose surface is coated with the first solid electrolyte material 111.

The second electrolyte material 100 may be produced by the following method.

In an example, when the second electrolyte material 100 composed of Li, Y, Cl, and Br is synthesized, a LiCl raw material powder, a LiBr raw material powder, a YBr₃ raw material powder, and a YCl₃ raw material powder are mixed. The raw material powders may be mixed at a molar ratio adjusted in advance so as to offset the change in composition, which may occur during the synthesis process. In this way, the second electrolyte material 100 is produced.

The positive electrode active material 110 whose surface is coated with the first solid electrolyte material 111 and the second electrolyte material 100 are mixed to produce the positive electrode material 1000 in the first embodiment.

### Second Embodiment

Hereinafter, a second embodiment will be described. The same explanation as that in the first embodiment is omitted as appropriate.

FIG. 2 is a cross-sectional view illustrating a schematic configuration of a battery 2000 according to the second embodiment.

The battery 2000 according to the second embodiment includes a positive electrode 201, an electrolyte layer 202, and a negative electrode 203. The positive electrode 201 contains the positive electrode material 1000 of the first embodiment. The electrolyte layer 202 is located between the positive electrode 201 and the negative electrode 203.

The above configuration reduces an increase in the internal resistance during charging of the battery 2000, increasing the charge and discharge capacity.

The volume ratio “v1:100−v1” of the positive electrode material 1000 to the second electrolyte material 100 in the positive electrode 201 may satisfy 30≤v1≤98. Here, v1 represents the volume ratio of the positive electrode material 1000 with the total volume of the positive electrode material 1000 and the second electrolyte material 100 in the positive electrode 201 being taken as 100. When 30≤v1 is satisfied, the battery can have a sufficient energy density. When v1≤98 is satisfied, the battery 2000 can operate with a high output.

The thickness of the positive electrode 201 may be greater than or equal to 10 μm and less than or equal to 500 μm. When the thickness of the positive electrode 201 is greater than or equal to 10 μm, the battery can have a sufficient energy density. When the thickness of the positive electrode 201 is less than or equal to 500 μm, the battery 2000 can operate with a high output.

The electrolyte layer 202 contains an electrolyte material. The electrolyte material may be a third solid electrolyte material. In other words, the electrolyte layer 202 may be a solid electrolyte layer.

As the third solid electrolyte material, the same material as the first solid electrolyte material 111 or the second electrolyte material 100 in the first embodiment may be used. In other words, the electrolyte layer 202 may contain the same material as the first solid electrolyte material 111 or the second electrolyte material 100 in the first embodiment.

This configuration can further improve the output density and the charge and discharge properties of the battery 2000.

As the third solid electrolyte material, the same material as the first solid electrolyte material 111 in the first embodiment may be used. In other words, the electrolyte layer 202 may contain the same material as the first solid electrolyte material 111 in the first embodiment.

The above configuration can reduce an increase in the internal resistance of the battery 2000 caused by oxidation of the electrolyte layer 202, further improving the output density and the charge and discharge properties of the battery 2000.

The third solid electrolyte material in the electrolyte layer 202 may be a halide solid electrolyte, a sulfide solid electrolyte, an oxide solid electrolyte, a polymer solid electrolyte, or a complex hydride solid electrolyte.

Examples of the oxide solid electrolyte of the third solid electrolyte material include NASICON-type solid electrolytes represented by LiTi₂(PO₄)₃ and element substitution products thereof, (LaLi)TiO₃-based perovskite solid electrolytes, LISICON-type solid electrolytes represented by Li₁₄ZnGe₄O₁₆, Li₄SiO₄, LiGeO₄, and element substitution products thereof, garnet-type solid electrolytes represented by Li₇La₃Zr₂O₁₂ and element substitution products thereof, Li₃PO₄ and N-substitution products thereof, and glass or glass ceramic in which Li₂SO₄, Li₂CO₃, or the like is added to a Li—B—O compound such as LiBO₂ and Li₃BO₃ as a base.

The polymer solid electrolyte of the third solid electrolyte material may be, for example, a compound of a polymer compound and a lithium salt. The polymer compound may have an ethylene oxide structure. The polymer compound having the ethylene oxide structure can contain a large amount of lithium salt. This can further improve the ionic conductivity. Examples of the lithium salt may include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from the exemplified lithium salts may be used alone. Alternatively, two or more lithium salts selected from the exemplified lithium salts may be used in combination.

Examples of the complex hydride solid electrolyte of the third solid electrolyte material may include LiBH₄—LiI and LiBH₄—P₂S₅.

The electrolyte layer 202 may contain the third solid electrolyte material as a main component. In other words, the electrolyte layer 202 may contain the third solid electrolyte material, for example, in a mass ratio of greater than or equal to 50% (i.e., greater than or equal to 50% by mass) to the whole electrolyte layer 202.

The above configuration can further improve the charge and discharge properties of the battery.

The electrolyte layer 202 may contain the third solid electrolyte material, for example, in a mass ratio of greater than or equal to 70% (i.e., greater than or equal to 70% by mass) to the whole electrolyte layer 202.

The above configuration can further improve the charge and discharge properties of the battery 2000.

The electrolyte layer 202 including the third solid electrolyte material as a main component may further contain inevitable impurities, starting raw materials used in synthesis of the third solid electrolyte material, by-products, degraded products, or the like.

The electrolyte layer 202 may contain the third solid electrolyte material in a mass ratio of 100% (i.e., 100% by mass) to the whole electrolyte layer 202, excluding, for example, inevitable impurities.

The above configuration can further improve the charge and discharge properties of the battery 2000.

The electrolyte layer 202 may be composed solely of the third solid electrolyte material.

The electrolyte layer 202 may contain two or more of the materials listed as the examples of the third solid electrolyte material. For example, the electrolyte layer 202 may contain a halide solid electrolyte and a sulfide solid electrolyte.

The thickness of the electrolyte layer 202 may be greater than or equal to 1 μm and less than or equal to 300 μm. When the thickness of the electrolyte layer 202 is greater than or equal to 1 μm, a short circuit is less likely to occur between the positive electrode 201 and the negative electrode 203. When the thickness of the electrolyte layer 202 is less than or equal to 300 μm, the battery 2000 can operate with a high output.

The negative electrode 203 contains a material capable of intercalation and deintercalation of metal ions (for example, lithium ions). The negative electrode 203 contains, for example, a negative electrode active material.

Examples of the negative electrode active material may include metal materials, carbon materials, oxides, nitrides, tin compounds, and silicon compounds. The metal material may be a pure metal. Alternatively, the metal material may be an alloy. Examples of the metal material include lithium metal and a lithium alloy. Examples of the carbon material include natural graphite, coke, graphitizing carbon, carbon fibers, spherical carbon, artificial graphite, and amorphous carbon. In view of capacity density, silicon, tin, a silicon compound, or a tin compound may be used.

The negative electrode 203 may contain a solid electrolyte material. The solid electrolyte material may be any of the solid electrolyte materials listed as examples of the materials constituting the electrolyte layer 202. The above configuration can improve the lithium-ion conductivity in the negative electrode 203 and enables the battery 2000 to operate with a high output.

The median diameter of the negative electrode active material may be greater than or equal to 0.1 μm and less than or equal to 100 μm. When the median diameter of the negative electrode active material is greater than or equal to 0.1 μm, the negative electrode active material and the solid electrolyte material can be in a good dispersion state in the negative electrode. This improves the charge and discharge properties of the battery 2000. When the median diameter of the negative electrode active material is less than or equal to 100 μm, the lithium diffusion in the negative electrode active material is accelerated. This enables the battery 2000 to operate with a high output.

The median diameter of the negative electrode active material may be larger than the median diameter of the solid electrolyte material included in the negative electrode 203. With this configuration, the negative electrode active material and the solid electrolyte material can be in a good dispersion state.

The volume ratio “v2:100−v2” of the negative electrode active material to the solid electrolyte material in the negative electrode 203 may satisfy 30≤v2≤95. Here, v2 represents the volume ratio of the negative electrode active material with the total volume of the negative electrode active material and the solid electrolyte material in the negative electrode 203 being taken as 100. When 30≤v2 is satisfied, the battery can have a sufficient energy density. When v2≤95 is satisfied, the battery 2000 can operate with a high output.

The thickness of the negative electrode 203 may be greater than or equal to 10 nm and less than or equal to 500 μm. When the thickness of the negative electrode 203 is greater than or equal to 10 μm, the battery 2000 can have a sufficient energy density. When the thickness of the negative electrode 203 is less than or equal to 500 μm, the battery 2000 can operate with a high output.

At least one selected from the group consisting of the positive electrode 201, the electrolyte layer 202, and the negative electrode 203 may contain a binder to improve the adhesion between particles. The binder is used to improve the binding properties of the materials that constitute the electrode. Examples of the binder include polyvinylidene fluoride, polytetrafluoroethylene, polyethylene, polypropylene, an aramid resin, polyamide, polyimide, polyimide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymetachrylic acid ethyl ester, polymethacrylic acid hexyl ester, polyvinyl acetate, polyvinylpyrrolidone, polyether, polyethersulfone, hexafluoropolypropylene, styrene butadiene rubber, and carboxymethyl cellulose. Furthermore, the binder may be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadien. Alternatively, a mixture of two or more selected from the above materials may also be used.

At least one of the positive electrode 201 or the negative electrode 203 may contain a conductive additive to improve the electronic conductivity. Examples of the conductive additive include graphites such as natural graphite and artificial graphite, carbon blacks such as acetylene black and Ketjen black, conductive fibers such as carbon fibers and metal fibers, metal powders such as a fluorocarbon powder and an aluminum powder, conductive whiskers such as zinc oxide whiskers and potassium titanate whiskers, conductive metal oxides such as titanium oxide, and conductive polymers such as polyaniline, polypyrrole, and polythiophene. When a carbon conductive additive is used as a conductive additive, the cost can be reduced.

Examples of the shape of the battery 2000 according to the second embodiment include a coin-like shape, a cylindrical shape, a rectangular shape, a sheet-like shape, a button-like shape, a flat shape, and a multilayer shape.

The battery 2000 may be produced by, for example, providing the positive electrode material 1000, a material for forming an electrolyte layer, and a material for forming a negative electrode and then producing a stack including, in this order, a positive electrode, an electrolyte layer, and a negative electrode using a known method.

### Third Embodiment

Hereinafter, a third embodiment will be described. The same explanation as that in the first embodiment is omitted as appropriate.

FIG. 3 is a cross-sectional view illustrating a schematic configuration of a battery 3000 according to the third embodiment.

The battery 3000 according to the third embodiment includes a positive electrode 201, an electrolyte layer 202, and a negative electrode 203. The positive electrode 201 contains the positive electrode material 1000 of the first embodiment. The electrolyte layer 202 is located between the positive electrode 201 and the negative electrode 203. The electrolyte layer 202 includes a first electrolyte layer 301 and a second electrolyte layer 302. The first electrolyte layer 301 is in contact with the positive electrode 201, and the second electrolyte layer 302 is in contact with the negative electrode 203.

The above configuration can reduce an increase in the internal resistance of the battery 3000 during charging.

The first electrolyte layer 301 may contain the same material as the first solid electrolyte material 111.

The first electrolyte layer 301 that is in contact with the positive electrode 201 contains the same material as the first solid electrolyte material 111 having high oxidation resistance. This configuration can reduce the oxidative degradation of the first electrolyte layer 301, reducing an increase in the internal resistance of the battery 3000 during charging.

The first electrolyte layer 301 may contain the same material as the second electrolyte material 100.

The second electrolyte layer 302 may contain a material different from that of the first solid electrolyte material 111.

The second electrolyte layer 302 may contain the same material as the second electrolyte material 100.

In view of the reduction resistance of the solid electrolyte material, the reduction potential of the solid electrolyte material contained in the first electrolyte layer 301 may be lower than that of the solid electrolyte material contained in the second electrolyte layer 302. The above configuration enables the solid electrolyte material in the first electrolyte layer 301 to be used without reduction. This can improve the charge and discharge efficiency of the battery 3000.

For example, the second electrolyte layer 302 may contain a sulfide solid electrolyte. Here, the reduction potential of the sulfide solid electrolyte in the second electrolyte layer 302 is lower than that of the solid electrolyte material in the first electrolyte layer 301. The above configuration enables the solid electrolyte material in the first electrolyte layer 301 to be used without reduction. This can improve the charge and discharge efficiency of the battery 3000.

The thickness of each of the first electrolyte layer 301 and the second electrolyte layer 302 may be greater than or equal to 1 μm and less than or equal to 300 μm. When the thickness of the first electrolyte layer 301 and the second electrolyte layer 302 is greater than or equal to 1 μm, a short circuit is less likely to occur between the positive electrode 201 and the negative electrode 203. When the thickness of each of the first electrolyte layer 301 and the second electrolyte layer 302 is less than or equal to 300 μm, the battery 3000 can operate with a high output.

### EXAMPLES

Hereafter, the present disclosure will be described in further detail with reference to Examples.

### Example 1

### Production of Positive Electrode Active Material having Surface Coated with First Solid Electrolyte Material

In an argon glove box (hereinafter, referred to as “in an argon atmosphere”), 100.1 mg of niobium ethoxide (manufactured by Sigma-Aldrich Co. LLC) and 16.4 mg of lithium ethoxide (manufactured by Sigma-Aldrich Co. LLC) were dissolved in 3 mL of super dehydrated ethanol (manufactured by FUJIFILM Wako Pure Chemical Corporation) to produce a coating solution.

Into a mortar, 1.00 g of the positive electrode active material LiNi_{0.5}Mn_{1.5}O₄ was put, and the whole amount of the prepared coating solution was put in the mortar and mixed, and then ethanol was evaporated to produce a powder. The resulting powder was heat-treated at 350° C. for 3 hours to produce the positive electrode active material whose surface is coated with LiNbO₃, which is the first solid electrolyte material in Example 1.

### Production of Second Electrolyte Material

In an argon atmosphere, raw material powders LiBr, YBr₃, LiCl, and YCl₃ were weighed to be in the molar ratio of LiBr:YBr₃:LiCl:YCl₃=1:1:5:1. Then, the powders were subjected to a milling treatment at 600 rpm for 25 hours by using a planetary ball mill (Model P-7 produced by Fritsch) to produce a Li₃YBr₂Cl₄ powder as the second electrolyte material. In Examples 1 to 4 and Reference Example 1 below, Li₃YBr₂ Cl₄ was used as the second electrolyte material.

### Production of Positive Electrode Material

The positive electrode active material whose surface is coated with the first solid electrolyte material LiNbO₃ of Example 1, the second electrolyte material, and Vapor Grown Carbon Fiber (VGCF (manufactured by Showa Denko K.K.)) as a conductive additive were weighed to be in a mass ratio of 73.7:25.3:1.0 and were mixed in a mortar to produce the positive electrode material of Example 1. Table 1 indicates the mass ratio of the first solid electrolyte material to the positive electrode active material in the positive electrode material of Example 1.

### Example 2

### Production of Positive Electrode Active Material having Surface Coated with First Solid Electrolyte Material

In an argon atmosphere, 20.0 mg of niobium ethoxide (manufactured by Sigma-Aldrich Co. LLC) and 3.3 mg of lithium ethoxide (manufactured by Sigma-Aldrich Co. LLC) were dissolved in 3 mL of super dehydrated ethanol (manufactured by FUJIFILM Wako Pure Chemical Corporation) to produce a coating solution.

Into a mortar, 1.00 g of the positive electrode active material LiNi_{0.5}Mn_{1.5}O₄ was put, and the whole amount of the prepared coating solution was put into the mortar and mixed, and then ethanol was evaporated to produce a powder. The resulting powder was heat-treated at 350° C. for 3 hours to produce the positive electrode active material whose surface is coated with LiNbO₃, which is the first solid electrolyte material of Example 2.

### Production of Positive Electrode Material

The positive electrode active material whose surface is coated with the first solid electrolyte material LiNbO₃ of Example 2, the second electrolyte material Li₃YBr₂Cl₄, and a conductive additive VGCF were weighed to be in a mass ratio of 73.0:26.0:1.0 and mixed in a mortar to produce the positive electrode material of Example 2. Table 1 indicates the mass ratio of the first solid electrolyte material to the positive electrode active material in the positive electrode material of Example 2.

### Example 3

### Production of Positive Electrode Active Material having Surface Coated with First Solid Electrolyte Material

In an argon atmosphere, 50.0 mg of niobium ethoxide (manufactured by Sigma-Aldrich Co. LLC) and 8.2 mg of lithium ethoxide (manufactured by Sigma-Aldrich Co. LLC) were dissolved in 3 mL of super dehydrated ethanol (manufactured by FUJIFILM Wako Pure Chemical Corporation) to produce a coating solution.

Into a mortar, 1.00 g of the positive electrode active material LiNio5Mni504 was put, and the whole amount of the prepared coating solution was put in the mortar and mixed, and then ethanol was evaporated to produce a powder. The resulting powder was heat-treated at 350° C. for 3 hours to produce the positive electrode active material whose surface is coated with LiNbO₃, which is the first solid electrolyte material of Example 3.

### Production of Positive Electrode Material

The positive electrode active material whose surface is coated with the first solid electrolyte material LiNbO₃ of Example 3, the second electrolyte material Li₃YBr₂Cl₄, and a conductive additive VGCF were weighed to be in a mass ratio of 73.3:25.8:1.0 and were mixed in a mortar to produce the positive electrode material of Example 3. Table 1 indicates the mass ratio of the first solid electrolyte material to the positive electrode active material in the positive electrode material of Example 3.

### Example 4

### Production of Positive Electrode Active Material having Surface Coated with First Solid Electrolyte Material

In an argon atmosphere, 200.2 mg of niobium ethoxide (manufactured by Sigma-Aldrich Co. LLC) and 32.7 mg of lithium ethoxide (manufactured by Sigma-Aldrich Co. LLC) were dissolved in 3 mL of super dehydrated ethanol (manufactured by FUJIFILM Wako Pure Chemical Corporation) to produce a coating solution.

Into a mortar, 1.00 g of the positive electrode active material LiNi_{0.5}Mn_{1.5}O₄ was put, and the whole amount of the prepared coating solution was put in the mortar and mixed, and then ethanol was evaporated to produce a powder. The resulting powder was heat-treated at 350° C. for 3 hours to produce the positive electrode active material whose surface is coated with LiNbO₃, which is the first solid electrolyte material of Example 4.

### Production of Positive Electrode Material

The positive electrode active material whose surface is coated with the first solid electrolyte material LiNbO₃ of Example 4, the second electrolyte material Li₃YBr₂Cl₄, and a conductive additive VGCF were weighed to be in a mass ratio of 74.5:24.5 0.9 and were mixed in a mortar to produce the positive electrode material of Example 4. Table 1 indicates the mass ratio of the first solid electrolyte material to the positive electrode active material in the positive electrode material of Example 4.

### Example 5

### Production of Second Electrolyte Material

In a dry atmosphere having a dew point of less than or equal to −30° C. (hereinafter, referred to as “dry atmosphere”), Li₂O₂ and TaCl₅ as raw material powders were provided in a molar ratio of 1.2:2. These raw material powders were ground and mixed in a mortar to produce a mixed powder. The resulting mixed powder was subjected to a milling treatment at 600 rpm for 24 hours by using a planetary ball mill. The mixed powder was then heat-treated at 200° C. for 6 hours. The second electrolyte material of Example 5 was produced in this way.

The positive electrode material of Example 5 was produced in the same way as in Example 1, except for the second electrolyte material. Table 1 indicates the mass ratio of the first solid electrolyte material to the positive electrode active material in the positive electrode material of Example 5.

### Example 6

### Production of Second Electrolyte Material

In an argon glove box having a dew point of less than or equal to −60° C., LiCl and YCl₃ as raw material powders were provided in a molar ratio of 2.7:1.1. Then, the powders were subjected to a milling treatment at 600 rpm for 25 hours by using a planetary ball mill (Model P-5 produced by Fritsch) to produce a powder of Li₂₇Y₁₁Cl₆ as the second electrolyte material.

The positive electrode material of Example 6 was produced in the same way as in Example 1, except that Li_{2.7}Y_{1.1}Cl₆ was used as the second electrolyte material. Table 1 indicates the mass ratio of the first solid electrolyte material to the positive electrode active material in the positive electrode material of Example 6.

### Example 7

The positive electrode material of Example 7 was produced in the same way as in Example 1, except that Li₆PS₅Cl was used as the second electrolyte material. Table 1 indicates the mass ratio of the first solid electrolyte material to the positive electrode active material in the positive electrode material of Example 7.

### Reference Example 1

### Production of Positive Electrode Material

The positive electrode active material LiNi_{0.5}Mn_{1.5}O₄, the second electrolyte material Li₃YBr₂Cl₄, of Example 1, and a conductive additive VGCF were weighed to be in a mass ratio of 72.8:26.2:1.0 and mixed in a mortar to produce the positive electrode material of Reference Example 1.

### Reference Example 2

### Production of Positive Electrode Material

The positive electrode active material LiNi_{0.5}Mn_{1.5}O₄, the second electrolyte material of Example 5, and a conductive additive VGCF were weighed to be in a mass ratio of 72.8:26.2:1.0 and were mixed in a mortar to produce the positive electrode material of Reference Example 2.

### Reference Example 3

### Production of Positive Electrode Material

The positive electrode active material LiNi_{0.5}Mn_{1.5}O₄, the second electrolyte material Li_{2.7}Y_{1.1}Cl₆ of Example 6, and a conductive additive VGCF were weighed to be in a mass ratio of 72.8:26.2:1.0 and were mixed in a mortar to produce the positive electrode material of Reference Example 3.

### Reference Example 4

### Production of Positive Electrode Material

The positive electrode active material LiNi_{0.5}Mn_{1.5}O₄, the second electrolyte material Li₆PS₅Cl of Example 7, and a conductive additive VGCF were weighed to be in a mass ratio of 72.8:26.2:1.0 and were mixed in a mortar to produce the positive electrode material of Reference Example 4.

### Production of Battery

Batteries including the positive electrode materials of Examples 1 to 7 and Reference Examples 1 to 4 described above were produced by the following process.

### Example 1

First, 80 mg of Li₆PS₅Cl was put into an insulating outer tube and was press-formed at a pressure of 2 MPa. Next, 20 mg of the second electrolyte material used in the positive electrode material of Example 1 was put and press-formed at a pressure of 2 MPa. Furthermore, 9.9 mg of the positive electrode material of Example 1 was put and press-formed at a pressure of 720 MPa. A stack including the positive electrode and the solid electrolyte layer was produced in this way.

Next, Li metal was stacked on a side of the solid electrolyte layer opposite the side in contact with the positive electrode. The Li metal was 200 μm thick. This was press-formed at a pressure of 2 MPa to produce a stack including the positive electrode, the solid electrolyte layer, and the negative electrode.

Next, stainless steel current collectors were placed on upper and lower surfaces of the stack, and current collection leads were attached to the current collectors.

Finally, the insulating outer tube was sealed with an insulating ferrule to block the outside air, and thus a battery of Example 1 was produced.

### Examples 2 to 7 and Reference Examples 1 to 4

Into each of insulating outer tubes, 80 mg of Li₆PS₅Cl was put and press-formed at a pressure of 2 MPa. Next, 20 mg of the second electrolyte materials used in the positive electrode materials of Examples 2 to 7 and Reference Examples 1 to 4 were put and press-formed at 2 MPa. The positive electrode materials of Examples 2 to 7 and Reference Examples 1 to 4 were added to the respective materials in such an amount that the content of the positive electrode active material LiNi_{0.5}Mn_{1.5}O₄ becomes 7 mg, and they were press-formed at a pressure of 720 MPa. The amount of the positive electrode material added was 9.7 mg in Example 2, 9.8 mg in Example 3, 10.3 mg in Example 4, 9.9 mg in Examples 5 to 7, and 9.6 mg in Reference Examples 1 to 4. A stack including the positive electrode and the solid electrolyte layer was produced in this way. Batteries of Examples 2 to 7 and Reference Examples 1 to 4 were produced in the same way as in that of Example 1, except for the above.

### Charge and Discharge Test

The batteries of Examples 1 to 7 and Reference Examples 1 to 4 were each subjected to a charge and discharge test under the following conditions.

The batteries were placed in a thermostat adjusted at 25° C.

The batteries were charged with a constant current at a current value of 42 μA corresponding to 0.05 C rate (20-hour rate) with respect to its theoretical capacity. The end-of-charge voltage was set at 5.0 V (vs. Li/Li⁺). Next, the end-of-discharge voltage was set at 3.5 V (vs. Li/Li⁺), and the batteries were discharged with a constant current.

Table 1 indicates the results of the charge and discharge tests on the batteries of Examples 1 to 7 and Reference Examples 1 to 4.

TABLE 1

| | | | First solid | | | | | |
|---|---|---|---|---|---|---|---|---|
| | Positive | | electrolyte | | | | Average | Coated/ |
| | electrode | First solid | material | Second | Charge | Discharge | discharge | uncoated |
| | active | electrolyte | mass ratio | electrolyte | capacity | capacity | voltage | capacity |
| | material | material | (%) | material | (mAh/g) | (mAh/g) | (V) | ratio |
| Example 1 | Li—Ni—Mn—O | Li—Nb—O | 4.7 | Li—Y—Br—Cl | 82 | 68 | 4.28 | 1172 |
| Example 2 | Li—Ni—Mn—O | Li—Nb—O | 0.93 | Li—Y—Br—Cl | 71 | 54 | 4.20 | 931 |
| Example 3 | Li—Ni—Mn—O | Li—Nb—O | 2.3 | Li—Y—Br—Cl | 77 | 58 | 4.22 | 1000 |
| Example 4 | Li—Ni—Mn—O | Li—Nb—O | 9.3 | Li—Y—Br—Cl | 68 | 41 | 4.28 | 707 |
| Example 5 | Li—Ni—Mn—O | Li—Nb—O | 4.7 | Li—Ta—Cl—O | 91 | 82 | 4.37 | 3.42 |
| Example 6 | Li—Ni—Mn—O | Li—Nb—O | 4.7 | Li—Y—Cl | 85 | 73 | 4.33 | 4.87 |
| Example 7 | Li—Ni—Mn—O | Li—Nb—O | 4.7 | Li—P—S—Cl | 94 | 71 | 4.32 | 10.4 |
| Reference | Li—Ni—Mn—O | — | — | Li—Y—Br—Cl | 0.97 | 0.058 | 3.42 | — |
| example 1 | | | | | | | | |
| Reference | Li—Ni—Mn—O | — | — | Li—Ta—Cl—O | 31 | 24 | 4.07 | — |
| example 2 | | | | | | | | |
| Reference | Li—Ni—Mn—O | — | — | Li—Y—Cl | 23 | 15 | 3.71 | — |
| example 3 | | | | | | | | |
| Reference | Li—Ni—Mn—O | — | — | Li—P—S—Cl | 38 | 6.8 | 3.83 | — |
| example 4 | | | | | | | | |

The coated/uncoated capacity ratios of Examples 1 to 4 in Table 1 are the ratios of the discharge capacities of Examples 1 to 4 to the discharge capacity of Reference Example 1. The coated/uncoated capacity ratio of Example 5 is the ratio of the discharge capacity of Example 5 to the discharge capacity of Reference Example 2. The coated/uncoated capacity ratio of Example 6 is the ratio of the discharge capacity of Example 6 to the discharge capacity of Reference Example 3. The coated/uncoated capacity ratio of Example 7 is the ratio of the discharge capacity of Example 7 to the discharge capacity of Reference Example 4.

As indicated in Table 1, the positive electrode active material whose surface is coated with the first solid electrolyte material increases the charge and discharge capacity.

According to the present disclosure, the charge and discharge capacity increases.

The batteries according to the present disclosure may be utilized, for example, as all-solid-state lithium-ion rechargeable batteries.

What is claimed is:

1. A positive electrode material comprising:
a positive electrode active material;
a first solid electrolyte material coating at least a portion of a surface of the positive electrode active material; and
a second electrolyte material, wherein
the second electrolyte material contains Li and at least one selected from the group consisting of Cl and Br,
the first solid electrolyte material contains Li, Nb, and O, and
the positive electrode active material contains a material represented by the following composition formula (1):
LiNiₓMn₂₋ₓO₄ Formula (1)
where x satisfies 0<x<2.

2. The positive electrode material according to claim 1, wherein the composition formula (1) satisfies 0<x<1.

3. The positive electrode material according to claim 2, wherein the composition formula (1) satisfies x=0.5.

4. The positive electrode material according to claim 1, wherein the first solid electrolyte material contains lithium niobate.

5. The positive electrode material according to claim 1, wherein a mass ratio of the first solid electrolyte material to the positive electrode active material is greater than or equal to 0.50%.

6. The positive electrode material according to claim 5, wherein a mass ratio of the first solid electrolyte material to the positive electrode active material is greater than or equal to 0.93%.

7. The positive electrode material according to claim 1, wherein the second electrolyte material further contains at least one selected from the group consisting of metallic elements other than Li and metalloid elements.

8. The positive electrode material according to claim 7, wherein the second electrolyte material contains a material represented by the following composition formula (2):
Li_{α}M_{β}X_{γ}O₆₇ Formula (2)
where α, β, and γ are values greater than 0, δ is a value greater than or equal to 0,
M is at least one selected from the group consisting of metallic elements other than Li and metalloid elements, and
X is at least one element selected from the group consisting of Cl and Br.

9. The positive electrode material according to claim 8, wherein M contains at least one selected from the group consisting of Y and Ta. The positive electrode material according to claim 8, wherein the composition formula (2) satisfies:
1≤α≤4;
0<β≤2;
3≤γ<7; and
0≤δ≤2.

11. The positive electrode material according to claim 1, wherein the second electrolyte material further contains a sulfide solid electrolyte.

12. The positive electrode material according to claim 1, wherein the second electrolyte material contains Li₆PS₅Cl.

13. The positive electrode material according to claim 1, wherein the first solid electrolyte material is located between the positive electrode active material and the second electrolyte material.

14. A battery comprising:
a positive electrode;
a negative electrode; and
an electrolyte layer located between the positive electrode and the negative electrode, wherein
the positive electrode contains the positive electrode material according to claim

1.

15. The battery according to claim 14, wherein the electrolyte layer includes a first electrolyte layer and a second electrolyte layer, and
the first electrolyte layer is in contact with the positive electrode, and the second electrolyte layer is in contact with the negative electrode.

16. The battery according to claim 15, wherein the first electrolyte layer contains a material having a composition identical to that of the second electrolyte material.

17. The battery according to claim 15, wherein the second electrolyte layer contains a material having a different composition from the first solid electrolyte material.
